(19) United States
(12) Patent Application Publication
(10) Pub. No.: US 2010/0321339 A1
(43) Pub. Date: Dec. 23, 2010

(54) Diffractive optical touch input

(75) Inventor: Jyrki Kimmel, Tampere (FI)

Correspondence Address: HARRINGTON & SMITH, 4 RESEARCH DRIVE, Suite 202, SHELTON, CT, 06484-6212, US

(73) Assignee: Nokia Corporation

(21) Appl. No.: 12/456,534

(22) Filed: Jun. 18, 2009

(51) Int. Cl. G06F 3/042

(52) U.S. Cl. 345/175

(57) ABSTRACT

A display apparatus includes a display having a pixelated display surface and an opposed surface, and a substantially planar light guide structure having a light emitting surface that is optically coupled to the opposed surface of the display. The light emitting surface of the light guide structure has an array of gratings arranged as a plurality of sub-arrays of gratings. At least some of the gratings of a given sub-array are configured to emit display light towards the opposed surface of said display, and at least one of the gratings of the given sub-array is configured to emit non-display light (e.g., IR light) towards the opposed surface of the display and to receive non-display light that is at least one of reflected from and scattered by an object that is proximate to the pixelated display surface. The display apparatus also comprises a plurality of light sensors that are disposed along at least two edges of the light guide structure and that are configured to detect the received non-display light. The plurality of light sensors have outputs configured to be connected to a data processor that operates in accordance with a stored program to determine a location of the object on the pixelated display surface.

### TECHNICAL FIELD

The exemplary and non-limiting embodiments of this invention relate generally to user interface systems, methods, devices and computer programs and, more specifically, relate to touch-sensitive user input devices, such as touch sensitive displays.

### BACKGROUND

This section is intended to provide a background or context to the invention that is recited in the claims. The description herein may include concepts that could be pursued, but are not necessarily ones that have been previously conceived, implemented or described. Therefore, unless otherwise indicated herein, what is described in this section is not prior art to the description and claims in this application and is not admitted to be prior art by inclusion in this section.

The following abbreviations that may be found in the specification and/or the drawing figures are defined as follows:
IR infrared
LCD liquid crystal display
LED light emitting diode

Some currently available flat panel displays have external touch structures to enable a user interface based on a touch input feature. However, the touch structure may be thicker than the display itself. Further, the presence of the touch structure may obstruct a portion of the light emanating from the display, thereby reducing the effectiveness of the display function.

### SUMMARY

The foregoing and other problems are overcome, and other advantages are realized, by the use of the exemplary embodiments of this invention.

In a first aspect thereof the exemplary embodiments of this invention provide a method that comprises out-coupling infrared (IR) light via a plurality of gratings from a light guide structure towards a surface of a display; in-coupling IR light that returns from at least one object above the surface to the light guide structure via at least the plurality of gratings; detecting the in-coupled IR light along at least one edge of the light guide structure; and determining at least one of a presence and spatial position of the at least one object relative to the surface of the display in accordance with the detected in-coupled IR light.

In a further aspect thereof the exemplary embodiments of this invention provide a display apparatus that comprises a display having a pixelated display surface and an opposed surface and a substantially planar light guide structure having a light emitting surface that is optically coupled to the opposed surface of the display. The light emitting surface of the light guide structure is comprised of an array of gratings arranged as a plurality of sub-arrays of gratings. At least some of the gratings of a given sub-array are configured to emit display light towards the opposed surface of said display, and at least one of the gratings of the given sub-array is configured to emit non-display light towards the opposed surface of the display and to receive non-display light that is at least one of reflected from and scattered by at least one object that is proximate to the pixelated display surface. The display apparatus also comprises a plurality of light sensors that are disposed along at least one edge of the light guide structure and that are configured to detect the received non-display light.

In a still further aspect thereof the exemplary embodiments of this invention provide an apparatus that comprises a display unit comprising a pixelated display surface and an opposed surface, and a substantially planar light guide structure having a light emitting surface that is optically coupled to the opposed surface of the display unit. The light emitting surface of the light guide structure is comprised of an array of gratings arranged as a plurality of sub-arrays of gratings. At least some of the gratings of a given sub-array are configured to emit display light towards the opposed surface of the display unit, and at least one of the gratings of the given sub-array is configured to emit non-display light towards the opposed surface of the display and to receive non-display light that is at least one of reflected from and scattered by at least one object that is proximate to the pixelated display surface. The display unit further comprises a plurality of light sensors that are disposed along at least one edge of the light guide structure and that are configured to detect the received non-display light. The apparatus further comprises at least one processor and at least one memory including computer program code. The at least one memory and the computer program code are configured to, with the at least one processor, cause the apparatus at least to perform at least one of determining a presence and location of the at least one object relative to the pixelated display surface based on output signals of the plurality of light sensors.

### BRIEF DESCRIPTION OF THE DRAWINGS

In the attached Drawing Figures:

FIG. 1 shows an enlarged side view and top view of a portion of a touch sensitive display in accordance with the exemplary embodiments of this invention.

FIG. 2 shows the display of FIG. 1 and a scattering object positioned near to a top surface.

FIG. 3 is a simplified block diagram of a device that includes the display of FIGS. 1 and 2, and shows IR sensors arranged around edges of a light guide structure.

FIG. 4 shows an exemplary timing between display activation periods and IR touch sensing periods.

FIG. 5 is a logic flow diagram that illustrates the operation of a method, and a result of execution of computer program instructions embodied on a computer readable memory, in accordance with the exemplary embodiments of this invention.

### DETAILED DESCRIPTION

The exemplary embodiments of this invention relate at least in part to diffractive optics that are integrated into a display, such as an LCD, to provide a touch detection functionality.

The use of the exemplary embodiments of this invention removes a need to provide additional, possibly light-obstructing, touch detection-related structures in a display.

The exemplary embodiments of this invention use slanted gratings for in-coupling and tailored grating profiles for out-coupling. The gratings are geometrically arranged in an array of pixels. Gratings may be used to provide backlight illumination in a flat panel display by arranging the in-coupling and out-coupling structures to couple in single red (R), green (G) and blue (B) light sources (generally visible display light), and to couple out the RGB light in a pattern defined by a pattern of pixels of an overlaid LCD display. In accordance with the exemplary embodiments of this invention there is added a matrix of gratings for non-display light (e.g., IR light) to provide the touch detection function.

For the input (both RGB and IR), light is coupled into a backlight structure using any technique suitable for use with LED light sources, such as butt coupling or lens-assisted collimated coupling. The light is fanned out (distributed) to the area of the display using a fan-out grating, or by any suitable technique. For the output, the light is coupled out of the backlight structure by the wavelength-specific structures at the output pixels, arranged in registration with the pixel matrix of the display panel. The wavelength-specific structures may comprise diffraction gratings. One specific grating is used for out-coupling the IR light. The touch detection function is implemented such that as a user touches an area on the top surface of the display structure IR light is reflected or scattered back toward the display structure. Part of the reflected/scattered light is coupled back into a light guide plate of the backlight structure, and directed toward the edges of the light guide plate.

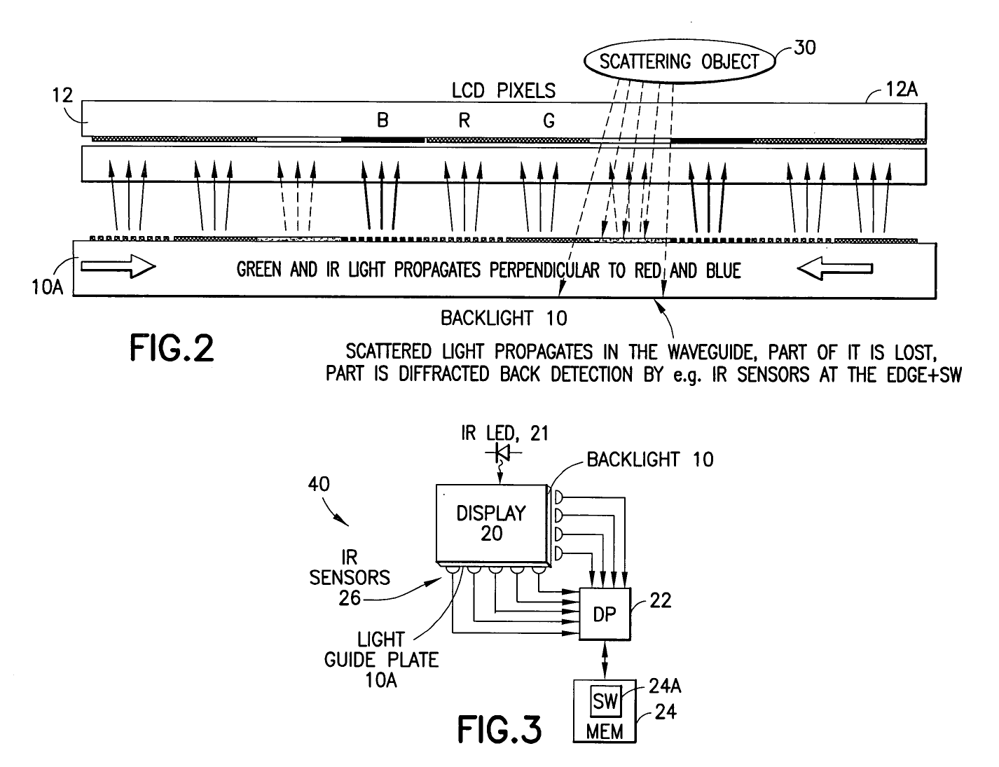

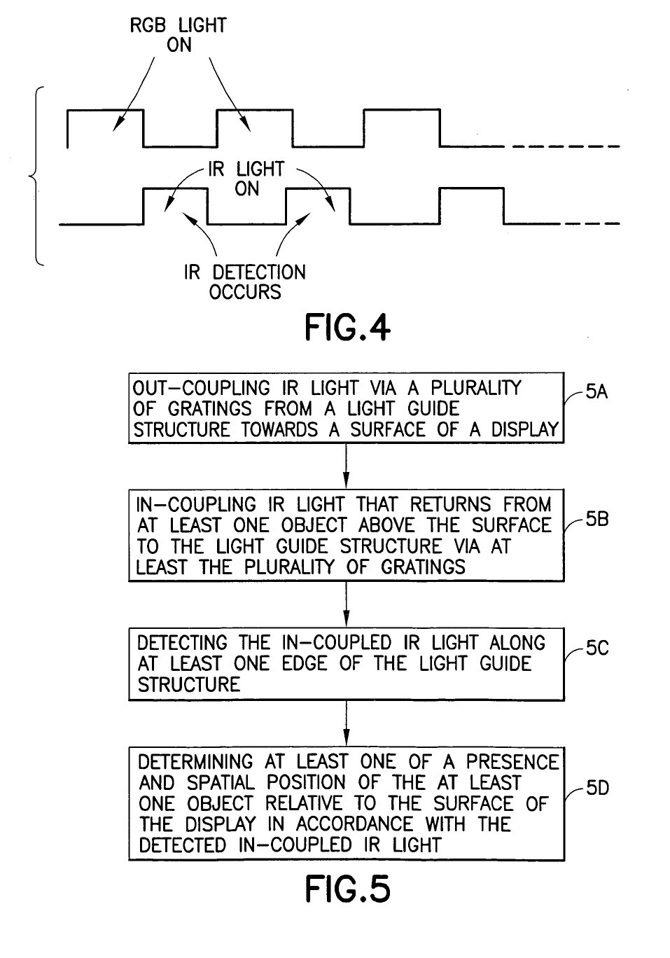

As is shown in FIG. 3, a device 40 includes at least one IR LED 21 (or other IR source) arranged to couple IR light into a light guide plate or structure 10A that forms a part of a backlight structure 10. IR light sensors 26 (photodetectors) are located at the edges of a display device 20, in particular at the edges of the light guide plate 10A. The IR light sensors 26 detect the IR light that is reflected/scattered back into the light guide plate 10A due to the presence of an object 30 that is touching or at least proximate to a top (pixelated) surface of the display 20 (see FIG. 2). That is, the display 20 includes a display surface that is divided or partitioned into individual pixels or subpixels, i.e., the display surface is pixelated. The same structure used for the display function is temporally separated from the display function by using the IR light during idle periods of the display 20 (see FIG. 4). This time multiplexing of the RGB and IR light makes it unnecessary to use specific IR filters for separating the IR light from the RGB light used to display information. The number of light sensors 26, and the spacing between them, is determined at least in part by the desired spatial accuracy of the touch interface. Software (SW) 24A comprised of computer program code stored in at least one memory 24 is used by at least one controller or data processor (DP) 22 to deduce at least one of the presence and the location of the user's finger (or pointing device, such as a stylus) from output signals of the IR sensors 26.

Note that the sensors 26 may be any type of sensor that is suitable for detecting the non-display light used for the touch detection function, e.g., the IR light, such as, but not limited to, photovoltaic or photoconductive sensor devices. The sensors 26 may be arranged along one edge of the light guide plate 10A, or along two perpendicular edges, or arranged at any desired locations enabling the detection of the object 30. Note also that the detection of the presence (and locations) of multiple objects 30 maybe accomplished, such as when a user touches the display surface with two or more fingers. Detection of the movement of the object or objects 30 can also be accomplished by the use of successive detections over a period of time, thereby enabling gesture-based user inputs to be detected, resolved and interpreted by the software 24A.

In FIG. 4 it can be noted that IR illumination and IR detection may occur essentially simultaneously. In general, the IR light scattered from the object 30 and coupled back into the light guide plate 10A (primarily by the red gratings) may be detected as an increase in the IR light intensity (over the background IR illumination intensity).

The device 40 may be any type of electronic device that includes a display function, such as a cellular phone or other type of wired or wireless communication apparatus, or a PDA, or a digital camera, or a gaming unit, as several non-limiting examples.

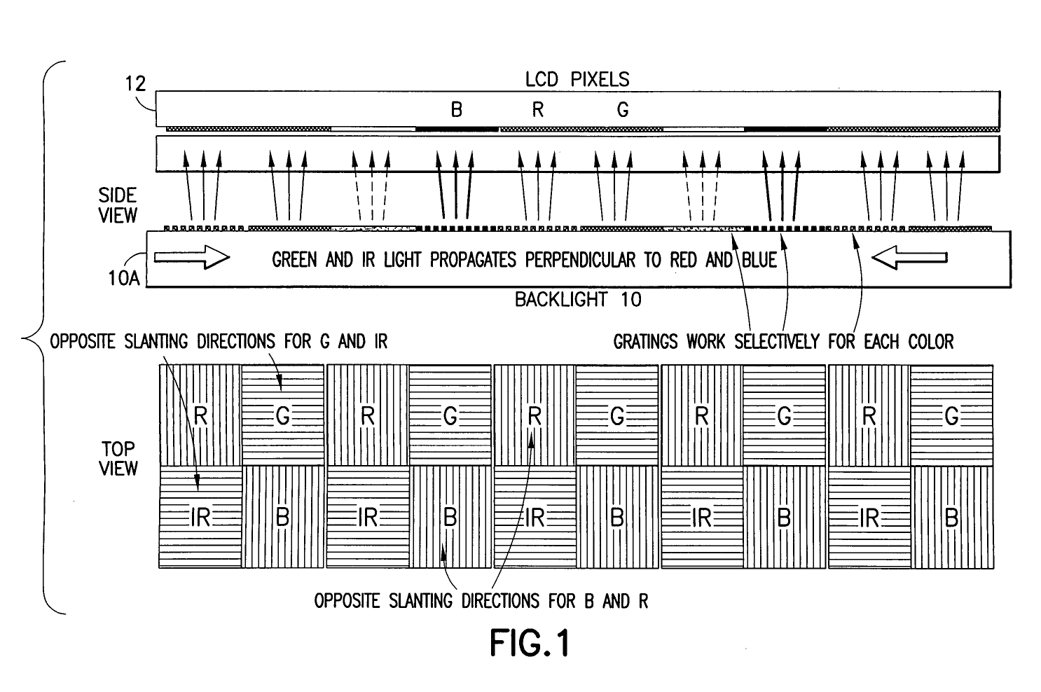

FIG. 1 shows a diffractive backlight structure 10 arranged in a matrix of gratings 11 with an array 12 of LCD pixels. An array of the gratings 11 operates selectively for each color. In this exemplary embodiment there are repeating 2×2 sub-arrays of R, G, B and IR gratings. In the backlight structure 10, more specifically in the light guide structure 10A, G and IR light propagates perpendicularly to the R and B light, and the respective grating lines and their slant directions are arranged accordingly. While a substantially square matrix is suggested in FIG. 1, other matrix geometries may be used as well.

In general, the dimensions of the individual gratings 11 are such that the grating area is about equal to or less than the area of the display pixels or subpixels (e.g., typically in the range of about 50 to about 100 microns in either dimension). The gratings 11 may be fabricated by any suitable process, such as by UV-embossing/replication from a fused silica master.

FIG. 2 shows the touch function in operation. IR light is scattered or reflected back from an object 30 positioned on or near to a top surface 12A of the LCD display 12. The scattered IR light propagates in the light guide structure 10A. Some is lost, while at least some reaches the edges of the light guide structure 10A and the IR sensors 26 positioned along the edges. The SW 24A determines, based on the outputs of the IR sensors 26, whether the object 30 is a finger or some other pointing device, as opposed to the device being, e.g., in a user's pocket or positioned display down on a desk or table top. The SW 24A also discriminates between an object of interest (e.g., a finger or stylus) and other objects, such as dust, etc. This discrimination may be based on the detected size of the object 30 (e.g., how many adjacently disposed sensors 26 simultaneously receive the IR light) relative to the size of the display area and/or on the persistence of the object 30 (e.g., an object having a size within a range of sizes associated with a finger or stylus that is present for at least some first predetermined period of time, but not longer than some second predetermined period of time).

Note that the LCD subpixel that is specific to the IR grating subpixel may not necessarily have any function regarding displaying visible information, although it may have such functionality. The LCD subpixel that is specific to the IR grating subpixel is configured to be in the transmissive state when the IR light is sent out and potentially scattered/reflected back. The IR subpixel array may be meshed together with the main LCD subpixel array intended for information display.

Note also that in FIG. 3 that the IR sensors 26 are shown disposed along two perpendicular edges of the light guide structure or plate 10A. In other embodiments the IR sensors 26 may be disposed along one, three or even four edges of the light guide structure 10A. As was noted above, the total number of IR sensors 26, and the spacing between them, is a function of the desired spatial resolution of a touch event on the surface 12A of the display 12.

The IR light may be coupled back into the backlight 10 in two perpendicular directions due to the specificity of the grating for IR light in one direction, and due to the coupling of IR light from the perpendicular gratings. This is the case as the IR light is out of the design wavelength of the grating diffraction rejection (that is, IR will be coupled from the R and B gratings since the wavelength design of these gratings is intended to discriminate between R and B, not between R/IR and B/IR).

One technical effect that is realized by the use of these exemplary embodiments of the invention is that the touch-sensitive display device 20 can be fabricated as an integrated package, in a manner similar to a conventional display, except for having a grating array for the IR light included, and the IR sensors 26 at the edges. This makes the touch-sensitive display device thinner, lighter, and more robust than conventional touch interface displays.

Based on the foregoing it should be apparent that the exemplary embodiments of this invention provide a method, apparatus and computer program(s) to provide a compact touch-sensitive user display apparatus.

FIG. 5 is a logic flow diagram that illustrates the operation of a method, and at least partially a result of execution of computer program instructions, in accordance with the exemplary embodiments of this invention. In accordance with these exemplary embodiments a method performs, at Block 5A, an operation of out-coupling IR light via a plurality of gratings from a light guide structure towards a surface of a display. At Block 5B there is an operation of in-coupling IR light that returns from at least one object above the surface to the light guide structure via at least the plurality of gratings. At Block SC there is an operation of detecting the in-coupled IR light along at least one edge of the light guide structure. At Block 5D there is an operation of determining at least one of a presence and spatial position of the at least one object relative to the surface of the display in accordance with the detected in-coupled IR light.

The various blocks shown in FIG. 5 may be viewed as method steps, and/or as operations that result from operation of computer program code, and/or as a plurality of coupled logic circuit elements constructed to carry out the associated function(s).

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

It should thus be appreciated that at least some aspects of the exemplary embodiments of the inventions may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, and in a communications device embodiment baseband circuitry and radio frequency circuitry.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

For example, while the exemplary embodiments have been described above in the context of certain grating parameters and dimensions, wavelengths of display (visible) light and non-display (generally not visible) light, numbers of gratings per sub-array and the like, these various parameters may be changed without departing from the scope of the exemplary embodiments of this invention.

In addition, the exemplary embodiments of this invention are not restricted for use with only LCD-type displays, as other display types (e.g., electrowetting) may be employed.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

What is claimed is:

1. A method, comprising:
out-coupling infrared (IR) light via a plurality of gratings from a light guide structure towards a surface of a display;
in-coupling IR light that returns from at least one object above the surface to the light guide structure via at least the plurality of gratings;
detecting the in-coupled IR light along at least one edge of the light guide structure; and
determining at least one of a presence and spatial position of the at least one object relative to the surface of the display in accordance with the detected in-coupled IR light.

2. The method of claim 1, performed during a period of time when the light guide structure conveys only the IR light.

3. The method of claim 1, where the IR light that returns from the object is at least one of reflected from and scattered by the object.

4. A display apparatus, comprising:
a display having a pixelated display surface and an opposed surface;
a substantially planar light guide structure having a light emitting surface that is optically coupled to the opposed surface of said display, said light emitting surface of said light guide structure comprised of an array of gratings arranged as a plurality of sub-arrays of gratings, where at least some of the gratings of a given sub-array are configured to emit display light towards said opposed surface of said display, and where at least one of the gratings of the given sub-array is configured to emit non-display light towards said opposed surface of said display and to receive non-display light that is at least one of reflected from and scattered by at least one object that is proximate to said pixelated display surface; and
a plurality of light sensors that are disposed along at least one edge of said light guide structure and configured to detect the received non-display light.

5. The display apparatus as in claim 4, where said plurality of light sensors have outputs configured to be connected to a data processor that operates in accordance with a stored program to determine at least one of a presence and location of the at least one object on the pixelated display surface.

6. The display apparatus of claim 4, where said display light comprises light having at least red, green and blue wavelengths, and where said non-display light comprises infrared light.

7. The display apparatus of claim 4, where said display is comprised of a liquid crystal display.

8. The display apparatus of claim 4, where a given sub-array of gratings is comprised of a 2×2 grating array, where one of the gratings of the 2×2 grating array is wavelength-selective for red display light, where one of the gratings of the 2×2 grating array is wavelength-selective for green display light, where one of the gratings of the 2×2 grating array is wavelength-selective for blue display light, and where one of the gratings of the 2×2 grating array is wavelength-selective for infrared non-display light.

9. The display apparatus of claim 4, where said light guide structure conveys the non-display light when it is not conveying the display light.

10. The display apparatus of claim 4, embodied in a communication device.

11. An apparatus, comprising:
a display unit comprising a pixelated display surface and an opposed surface, a substantially planar light guide structure having a light emitting surface that is optically coupled to the opposed surface of said display unit, said light emitting surface of said light guide structure comprised of an array of gratings arranged as a plurality of sub-arrays of gratings, where at least some of the gratings of a given sub-array are configured to emit display light towards said opposed surface of said display unit, and where at least one of the gratings of the given sub-array is configured to emit non-display light towards said opposed surface of said display and to receive non-display light that is at least one of reflected from and scattered by at least one object that is proximate to said pixelated display surface, said display unit further comprising a plurality of light sensors that are disposed along at least one edge of said light guide structure and configured to detect the received non-display light;
at least one processor; and
at least one memory including computer program code, the at least one memory and the computer program code configured to, with the at least one processor, cause the apparatus at least to perform at least one of determining a presence and location of the at least one object relative to the pixelated display surface based on output signals of the plurality of light sensors.

12. The apparatus of claim 11, where said display light comprises light having at least red, green and blue wavelengths, and where said non-display light comprises infrared light.

13. The apparatus of claim 11, where said display unit is comprised of a liquid crystal display.

14. The apparatus of claim 11, where a given sub-array of gratings is comprised of a 2×2 grating array, where one of the gratings of the 2×2 grating array is wavelength-selective for red display light, where one of the gratings of the 2×2 grating array is wavelength-selective for green display light, where one of the gratings of the 2×2 grating array is wavelength-selective for blue display light, and where one of the gratings of the 2×2 grating array is wavelength-selective for infrared non-display light.

15. The apparatus of claim 11, where said light guide structure conveys the non-display light when it is not conveying the display light.

16. The apparatus of claim 11, where said display unit comprises at least a part of a user input interface.

17. The apparatus of claim 11, embodied as a communication device.
